(19) United States
(12) Patent Application Publication
(10) Pub. No.: US 2019/0036543 A1
(43) Pub. Date: Jan. 31, 2019

(54) A Method of Protecting Data Using Compression Algorithms

(71) Applicant: Rodney SMITH, Wellington (NZ)

(72) Inventor: Rodney SMITH, Wellington (NZ)

(21) Appl. No.: 15/758,677

(22) PCT Filed: Sep. 2, 2016
(86) PCT No.: PCT/IB2016/055256

§ 371 Date: Mar. 8, 2018

(30) Foreign Application Priority Data
Sep. 9, 2015 (NZ) 712067

(51) Int. Cl. H03M 7/30; H04L 9/06

(52) U.S. Cl. CPC H03M 7/3088; H03M 7/40; H04L 2209/30; H04L 9/06

(57) ABSTRACT

A method of encrypting data using a sequence of two or more data compression algorithms wherein the output of one algorithm is the input of the next algorithm if any and one or more algorithms each produce output embodying one or more codec dictionaries and one algorithm produces output not embodying a codec dictionary which algorithm uses an external pre-existing codec dictionary as its source of references. Further where if more than one algorithm emits output embodying a codec dictionary, one such algorithm operates on bytes of input and another operates on

### TECHNICAL FIELD

This invention relates to the fields of data compression and data encryption and particularly to the field of the security of data transmitted in electronic form.

### BACKGROUND

Nowadays, communication often takes the form of information embodied in electronic transmissions including transmissions along metal wires, glass fibres, by electromagnetic radiation through air, and in other ways. Electronic digital computers often facilitate the transmission and storage of such information, and respective computing devices might include desktop computers, laptops, net books, tablets, smart phones and other devices.

It is well known that data transmitted by electronic or other means may be intercepted, copied and stored by unknown parties for one or more unknown purposes. For business, personal and other reasons, this is not ideal.

In encryption and compression, the original data is the data to be processed. In data compression, a codec system is a compression-decompression system. Decompression is the reverse of compression. Lossless codec decompression restores the original data. In lossy codec systems decompression restores an approximation to the original data. “Encryption” means transforming data into a form that hides its information content.

No codec system guarantees that the compressed output file or stream is smaller in length than the uncompressed input file or stream. “Uncompressed” in this context means not yet compressed by the current instance of the current compression algorithm. Such uncompressed data may be the output of a previous compression step. The cryptogram is the output of the encryption process. An encryption alphabet, or cipher alphabet, is a set of codewords of one or more symbols each, that could be used to comprise part or all of a cryptogram.

In data compression, repetition, called redundancy, is identified and removed by compression algorithms. A compression algorithm in any particular instance of its use may or may not be used for the purpose of compression.

One reason why the output of a compression algorithm might be longer than the input is that the original data may contain relatively little redundancy, and compression adds structure to the output typically in part related to control elements required to restore the original data.

One method of removing repetition from data is for subsequent instances of a given symbol group to be replaced by references, also called pointers or addresses, back to the first instance. Such pointer-reference pairs for a given symbol group value typically change within the output of a respective compression algorithm because of buffering and performance or other considerations, and one respective type of buffering is referred to as the sliding window.

If the reference plus associated codes such as a code to identify the reference as a reference, comprise fewer bits than the symbol group referenced, then compression has been achieved, but this is not guaranteed.

Alternatively the pointer and the symbol group pointed to might be contained within a separate data structure called an external codec dictionary. In this case the pointers in the compressed data reference symbol groups inside the external dictionary, not symbol groups within the compressed stream or file itself. Because such dictionaries are external to the compressed stream it is possible that the compressed stream consists entirely of references.

All data compression schemes use a form of codec dictionary, which is needed to reverse the compression process and recover the original data or in the case of lossy compression, an approximation of the original data.

When the pointers and their references are contained within the output of the compression algorithm, the pointer-reference pairs collectively comprise a codec dictionary, but one contained inside, or embodied within, the compressed stream or file.

A pointer value may be repeated in a compressed stream but not refer to the same symbol group or symbol group value. For example, when input data is processed in blocks, when the referencing system is reset for each block, a given pointer will refer to a symbol group within the current block. Pointers in different blocks may have the same value but refer to different symbol group values.

Some external dictionaries including the type described and illustrated in WO98/39723 are such that all symbol groups in the original data can be replaced by references to symbol groups within the dictionary. Since such external-dictionary methods completely transform the original, they can be thought of as performing complete encryption, and the external dictionary is the encryption key, or shared secret.

When an encrypted transmission comprises addresses of information contained inside a separate codec dictionary structure, because the dictionary is the encryption key, it is not transmitted with the address stream.

When an external codec dictionary is used as a cipher alphabet, the codewords of the alphabet are the references (pointers, addresses) to the symbol groups also contained within the external dictionary.

Generally speaking, in such systems, the larger the cipher alphabet the better the encryption. That is, the greater the number of unique symbols, or codewords, in the alphabet the better the encryption. The theoretical maximum for a 32-bit codeword is an encryption alphabet comprising 4,294,967,296 unique symbols. The number of permutations of such an alphabet is factorial 4,294,967,296.

In most dictionary-based codec systems, the codec dictionary is contained within the output of the compression step, that is, it is embodied within the compressed data. As mentioned, in one type of such embodied, or implicit, dictionary, it comprises references to first instances of a symbol group along with the first instances themselves.

For example, where the uncompressed data contains several instances of the word “Internet”, the first instance remains and subsequent instances are replaced by pointers to the starting position of the first instance, say position 123, along with a count of the number of letters in the respective word, 8. One or two delimiter codes may be added to the pointer to identify it as a pointer. Alternatively the pointer may indicate how many atomic symbols need to be passed in a backwards direction in order to arrive at the “I” of the first instance of “Internet”, along with the integer 8.

Extending the above example to input data processed in blocks, if several instances of the string “Internet” appear in the first block, then one instance will remain along with respective backward references to it. If “Internet” also appears several times in another block , the first instance will remain along with respective backwards references to it. In all likelihood the pointers in the second block will refer to a different starting position, or offset, compared with the first block, even though the same symbol-group value is being referenced.

One criticism of data compression as a form of encryption is that the source code of all major codec algorithms is in the public domain. For codec systems this criticism is only valid if the codec dictionary is contained within the compressed data, but it does not apply when the dictionary is separate.

Another criticism of data compression as a form of encryption is that data compression algorithms have a different purpose from encryption, namely reduction in overall bit size compared to hiding information, and that as a result compression algorithms are not optimised for hiding information and this makes them vulnerable to successful cryptographic attack.

A third criticism of data compression as a form of encryption is that while compression algorithms typically remove redundancy, or repetition, they do not remove all redundancy, and that residual redundancy is a cryptographic weakness. For example, in some sliding window compression schemes, there may be repetition of pointer values within a given block of compressed data.

While the last two of these three criticisms may be true of individual codec algorithms, it does not necessarily follow that several codec algorithms applied in sequence must suffer the same weaknesses. “Applied in sequence” in this context means that the input of the next algorithm is the output of the current algorithm. There are various ways to compress data. Different compression principles may be realised by different compression algorithms. A sequence of compression algorithms each realising a different compression principles might progressively remove and/or obfuscate redundancy.

It may be that several compression algorithms used in sequence could completely destroy frequency patterns of, that is, repetition within, the original data, or could destroy it to a sufficient extent to render successful cryptographic attack impracticable.

In this regard, it does not follow that the output of such a sequence of algorithms need be devoid of patterns. What is needed is that patterns, if they exist, are not inherited from the original data or data type. For example, they might be inherited without harm from structural elements of an external dictionary used as the encryption key. Furthermore, a cryptogram might inherit patterns from the original data but also different patterns from a second source such as an external dictionary such that a form of interference occurs between the two sets of patterns that makes decryption impracticable.

It is typically desirable in encryption that encrypting the same original data on different occasions yields different cryptograms, that is, cryptograms composed of different values. When a given codec dictionary is used as encryption key to encrypt the same original data on different occasions, an algorithm may be employed to modify the addresses of what would otherwise be the cryptogram in order to create a cryptogram composed of different address values on the different occasions.

One way to achieve this could be to include a random number in the dictionary header and a different random number in the cryptogram header which numbers are used in combination (e.g., multiplication then modulo) to yield different address values on different occasions of encrypting the same original data.

One implication of using a large external codec dictionary as an encryption key is that the number of possible keys in the respective key space is much greater than that of current encryption methods such as AES and RSA, which suggests stronger protection against quantum computer brute force key attack.

### SUMMARY OF THE INVENTION

The present invention is a method of protecting data in which the data is processed through a sequence of data compression algorithms the output of any one except the last being the input of the next.

These algorithms are of basic types: those whose output embodies a codec dictionary, and those that use an external pre-existing codec dictionary and whose output does not embody a codec dictionary.

Each type has a different purpose. The first purpose, which is the purpose of the first type, is to remove redundancy from the original data. Redundancy is also refereed to as frequency patterns or patterns. Thus the first step may also be said to be one of changing, reducing or destroying patterns within the original data. One or more algorithms are of this first type.

The second purpose, which is the purpose of the second type, is to provide a cipher alphabet for encrypting the output of the last algorithm in the sequence of the first type. One algorithm is of the second type.

Algorithms of first type would typically realise standard compression method such as RLE, LZ77, LZ78 or variant, in which the references and what they refer to (collectively, the codec dictionary) are contained within the output of the compression process and exist inside the compressed file or stream, as mentioned earlier.

The second type employs a codec method such as that described in WO98/39723 in which the codec dictionary is not embodied in the output of the compression process, and is a separate data structure accessed by the compression algorithm during compression in order to obtain the references, or codewords, to be used to comprise the encrypted data. The output of this compression step contains addresses of, or references to, places inside the separate codec dictionary which is the encryption key.

In some cases, the input to the first algorithm of the first type might already be compressed and algorithms of the first type might be skipped. Alternatively, algorithms of both the first and second types might be used whether or not the original data is already compressed.

In some cases, the same or similar codec algorithm might be used for both types of processing.

The purpose of the first type is to remove redundancy and thus respective dictionaries have a mainly codec purpose. For the algorithm of the second type the dictionary provides a cipher alphabet that is used as an encryption key to encode the output of the last algorithm of the first type.

There may be two or more algorithms of the first type, each of which will produce output embodying one or more codec dictionaries. For example, the first such algorithm might employ LZ77 encoding which processes byte-sized units of input. A second algorithm may use Huffman encoding which employs bit-wise processing, and the output will contain one or more embedded dictionaries in the form of Huffman trees.

The output of the algorithm of the second type will be the same on different occasions of encrypting the same original data. An additional step is applied to yield cryptograms composed of different address values when encrypting the same original data on different occasions.

For example, adding a random number to a header area of the dictionary at dictionary-creation time and a random number to a cryptogram header area at cryptogram-creation time, then applying a function that uses both random numbers to modify the dictionary addresses to yield the output addresses that are added to the cryptogram, such that both random numbers are needed to reverse the modification function.

Algorithms of the present invention may relate to each other in batch mode or in stream mode. In batch mode an algorithm processes an input file producing an output file, then this output file is the input of the next algorithm, if any. In stream mode, the next algorithm begins processing the output of the current algorithm before the current algorithm has finished processing its own input.

In many areas of business, community and personal life, security and privacy of information is important. The present invention has a general applicability in improving security and privacy for business, community and personal use of electronic communication generally.

The present invention may be used in a variety of different ways whose primary utility may not be limited to or may not relate to privacy and security of information. The purpose and use of the present invention is therefore expressly not limited to the purpose and use exemplified in the embodiments described herein.

### BRIEF DESCRIPTION OF THE DRAWINGS

The above described advantages and operation of the present invention will be more fully understood upon reading the following description of the preferred embodiment in conjunction with the drawings, of which:

FIG. 1 is a flow chart illustrating the step of creating a compressed stream embodying codec dictionaries developed from byte elements of the input data treated in blocks.

FIG. 2 is a flow chart illustrating the step of creating a compressed stream embodying a codec dictionary developed from bit elements of the input data being the output data of FIG. 1.

FIG. 3 is a flow chart illustrating the step of using an external codec dictionary as a cipher alphabet to encrypt the output of FIG. 2.

FIG. 4 is a flow chart illustrating the function of modifying the selected symbols of the cipher alphabet of FIG. 3, which symbols are references to items contained within the external codec dictionary, for the purpose of yielding a different final symbol when encrypting the same original data on different occasions.

### DESCRIPTION OF THE INVENTION

As required, a detailed embodiment of the present invention is disclosed herein; it is to be understood that the disclosed embodiment is merely exemplary of the invention, which may be embodied in various forms. Therefore specific structural and functional details disclosed herein are not to be interpreted as limiting, but merely as a basis for the claims and as a representative basis for teaching one skilled in the art to variously employ the present invention in virtually any appropriately detailed structure.

The present invention includes by way of reference the invention described in the patent specification of the present inventory published as WO98/39723.

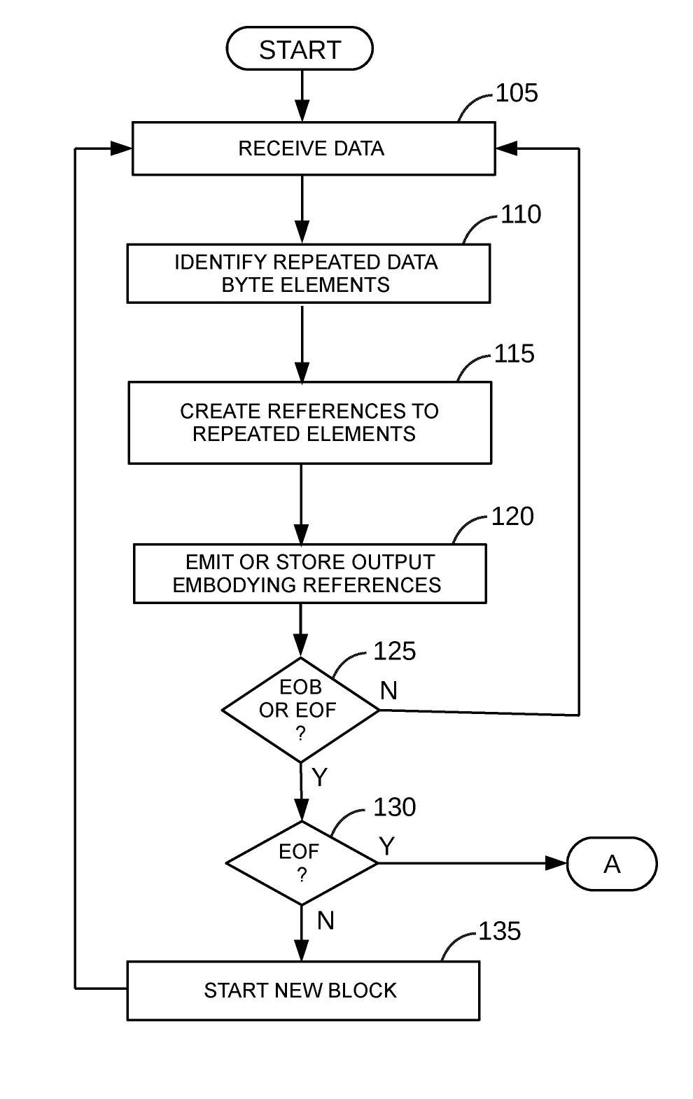

Referring now to FIG. 1, data is received 105 and repeated byte elements identified 110. References to repeated such elements are created 115. Processing uses blocks 125, 135, which is optional.

The references along with that referenced plus unreferenced elements if any comprise the output, 120. If the current processing position in the input stream is neither End of Input File nor End of Processing Block 125, N then further input is processed 105.

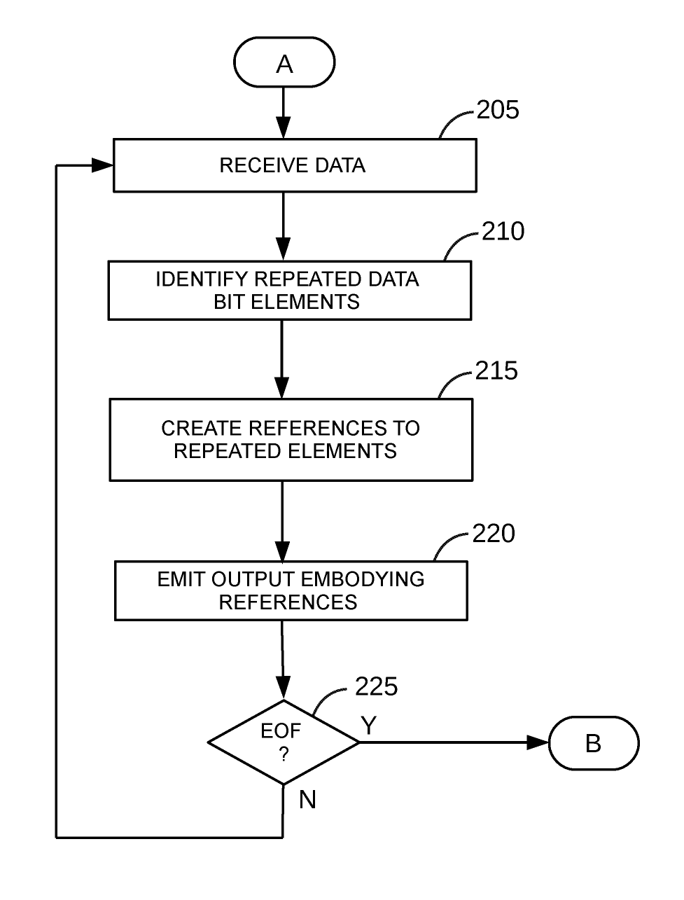

If the current processing position is End of Input File 125, Y and 130, Y then processing ends and control passes to FIG. 2. If the current processing position is End of Processing Block but not End of Input File 125, Y and 130, N then a new processing block is created and further input processed 105.

When an algorithm of an embodiment of the present invention does not employ blocks, then taking FIG. 1 as an example, the End of Block conditional test will not apply 125, EOB and 135, the test being only End of File 130.

Referring now to FIG. 2, the output of FIG. 1. is processed along the lines that the original data as input is processed in FIG. 1 except that the atomic unit of input data is the bit, and input blocks are not used.

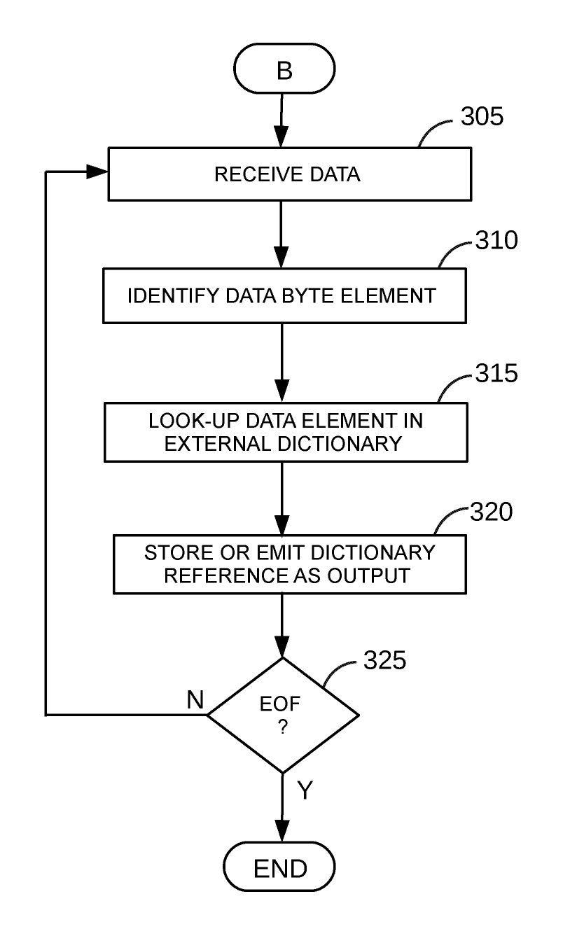

Referring now to FIG. 3, the output of FIG. 2 starts to be received 305. The next data element of this input 310 is one or more contiguous bytes of the output of FIG. 2. The value of this data element is looked up in the external codec dictionary and its dictionary reference identified 315.

The lookup process may entail a loop starting with first selecting the next byte of input, finding a dictionary instance of the same value, adding the value of the next byte again of input to the lookup string which is now two bytes long, looking up the dictionary again, and repeating this loop until a dictionary entry is not found as indicated in WO98/39723.

The algorithm emits as output or stores as output the found dictionary reference 320, which is the address within the dictionary of the dictionary instance of the selected input data element value, or of one of the dictionary instances of the selected input data element value in the case of a dictionary that contains more than one instance of the value of the selected input data element.

The output of FIG. 3 is a sequence of references, or addresses, to places inside the external codec dictionary which dictionary in the terminology of cryptology is the encryption key.

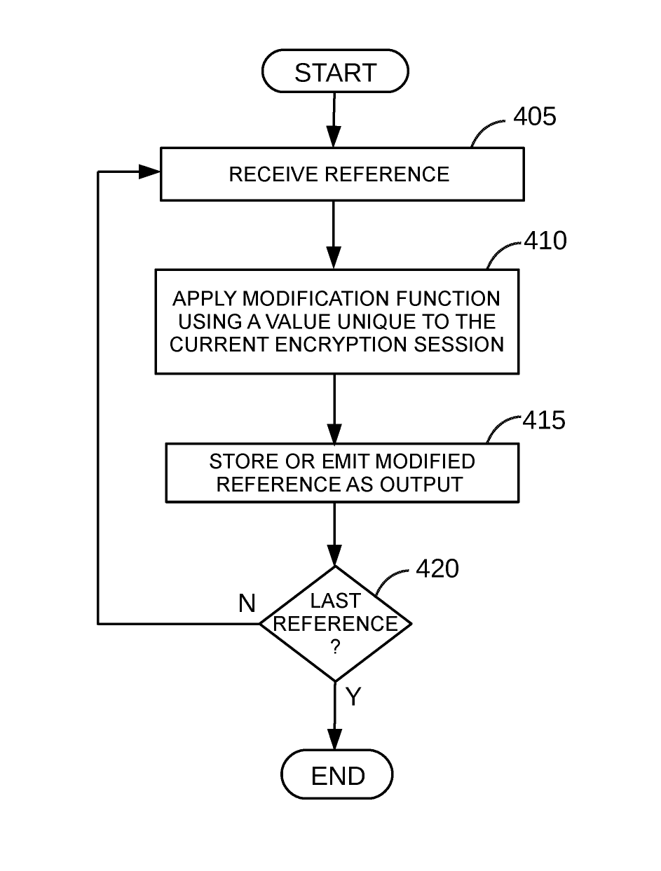

Referring now to FIG. 4, the atomic unit of input processing is the dictionary reference. The next reference is received 405, then a function is applied to the reference value that uses a value unique to the current processing session 410. For example, the product or XOR of two random numbers one generated during the current processing session and the other at dictionary creation time which is used to modify the reference in a reversible manner and the reversing algorithm requires access to the two random numbers and method of combination.

The modified reference is stored or emitted as output 415. This loop continues 420, N until all references are processed 420, Y.

1. A method of encrypting data, wherein:
said data is processed by a sequence of compression algorithms;
at least one compression algorithm produces output containing at least one embedded codec dictionary;
one compression algorithm produces output not containing an embedded codec dictionary.

2. A method according to claim 1 comprising the step of:
the compression algorithm that produces output not embodying an embedded codec dictionary processing as input the output of the only or last compression algorithm producing output containing at least one embedded codec dictionary.

3. A method according to claim 1 wherein:
a sequence of compression algorithms each produces output containing at least one embedded codec dictionary;
the output of any such algorithm being the input of the next, if any.

4. A method according to claim 1 wherein:
the compression algorithm that produces output not containing an embedded codec dictionary uses as its dictionary a pre-existing external codec dictionary;
the output of the algorithm comprising references to elements contained within the external codec dictionary.

5. A method according to claim 2 wherein:
the compression algorithm that produces output not embodying an embedded codec dictionary processing as its input the output of the only or last compression algorithm producing output containing at least one embedded codec dictionary before the only or last algorithm producing output containing at least one embedded codec dictionary has finished processing its input.

6. A method according to claim 3 wherein:
one algorithm operates on bytes as units of input;
another algorithm operates on bits as units of input.

7. A method of modifying references chosen for output according to claim 4 wherein:
a value created during the current processing session is used in conjunction with a value created before the current processing session to modify the reference value;
which modified reference value then replaces the reference value as output.

8. A method according to claim 7 wherein:
the value created during the current processing session is a random number;
this number is stored within a header, trailer or other area of the output;
the value created before the current processing session is a random number;
this number is created at or near dictionary creation time and stored inside the dictionary.

9. The method of claim 1 further comprising the steps of generating an output data file comprising a plurality of atomic units in the form of references to an extern codec dictionary; and storing the output data file.

10. The method of claim 9 wherein the step of generating an output data file modifies at least one of the atomic units prior to storing the output data file.

11. The method of claim 10 wherein the modification of the at least one of the atomic units involves a value unique to the instance of the step of generating.

12. The method of claim 4 further comprising the steps of generating an output data file comprising a plurality of atomic units in the form of references to an extern codec dictionary; and storing the output data file.

13. The method of claim 12 wherein the step of generating an output data file modifies at least one of the atomic units prior to storing the output data file.

14. The method of claim 13 wherein the modification of the at least one of the atomic units involves a value unique to the instance of the step of generating.

15. The method of claim 5 further comprising the steps of generating an output data file comprising a plurality of atomic units in the form of references to an extern codec dictionary; and storing the output data file.

16. The method of claim 15 wherein the step of generating an output data file modifies at least one of the atomic units prior to storing the output data file.

17. The method of claim 16 wherein the modification of the at least one of the atomic units involves a value unique to the instance of the step of generating.

18. The method of claim 7 further comprising the steps of generating an output data file comprising a plurality of atomic units in the form of references to an extern codec dictionary; and storing the output data file.

19. The method of claim 18 wherein the step of generating an output data file modifies at least one of the atomic units prior to storing the output data file.

20. The method of claim 19 wherein the modification of the at least one of the atomic units involves a value unique to the instance of the step of generating.
